(19) United States
(12) Patent Application Publication
(10) Pub. No.: US 2016/0033020 A1
(43) Pub. Date: Feb. 4, 2016

(54) VEHICULAR POWER TRANSMISSION DEVICE

(71) Applicant: HONDA MOTOR CO., LTD., Tokyo (JP)

(72) Inventors: Kazuki Ichikawa, Wako-shi (JP); Tsunehiro Kobayashi, Wako-shi (JP); Yuji Nishimura, Wako-shi (JP)

(73) Assignee: HONDA MOTOR CO., LTD., Tokyo (JP)

(21) Appl. No.: 14/781,429

(22) PCT Filed: Mar. 5, 2014
(86) PCT No.: PCT/JP2014/055613

§ 371 Date: Sep. 30, 2015

(30) Foreign Application Priority Data
Apr. 1, 2013 (JP) 2013-076170

(51) Int. Cl. F16H 29/04; F16H 37/08

(52) U.S. Cl. CPC F16H 29/04; F16H 37/084

(57) ABSTRACT

A vehicular power transmission device including a crank type continuously variable transmission is provided in which when the vehicle transitions to the deceleration traveling state, a second one-way clutch (69) is engaged to thus transmit to an engine (E) the driving force that has been transmitted back via auxiliary driving force transmission method (54), thereby enabling engine braking to be operated. In this process, although a difference occurs in the time lag before the second one-way clutch (69) is engaged depending on the magnitude of the differential rotation, since the rotation of an input shaft (12) is braked or assisted by the driving force of an electric motor (24) of a shift actuator (23) changing the gear ratio of a continuously variable transmission (T) so that the time taken for the differential rotation to become zero coincides with the preset predetermined time, it is possible to make the time lag before engine braking operates uniform, thus eliminating any disagreeable sensation for a driver.

### TECHNICAL FIELD

The present invention relates to a vehicular power transmission device that, by utilizing an electric motor to drive a shift actuator, enables the time lag before engine braking operates when a vehicle transitions to a deceleration traveling state to be made constant.

### BACKGROUND ART

A crank type continuously variable transmission that converts rotation of an input shaft connected to an engine into back-and-forth movements, having different phases from each other, of a plurality of connecting rods, and converts the back-and-forth movement of the plurality of connecting rods into rotation of an output shaft by a plurality of one-way clutches is known from Patent Document 1 below.

### RELATED ART DOCUMENTS

### Patent Documents

Patent Document 1: Japanese Patent Publication No. 2005-502543

### SUMMARY OF THE INVENTION

### Problems to be Solved by the Invention

In such a crank type continuously variable transmission, since a first one-way clutch is disposed between the connecting rod and the output shaft, engine braking cannot be operated by transmitting the driving force from the output shaft side back to the input shaft side. In order to enable engine braking to be operated, it is necessary to provide auxiliary driving force transmission means in which for example the input shaft and the output shaft are connected by means of an endless chain or a gear train, and to provide a second one-way clutch on the output shaft side, the second one-way clutch disengaging when traveling by means of the driving force of the engine and engaging when engine braking is operated.

However, when the vehicle transitions from an acceleration traveling state or a constant-speed traveling state to a deceleration traveling state, the second one-way clutch provided on the auxiliary driving force transmission means does not engage when differential rotation is present between an outer race and an inner race thereof, but when the rotational speed of the input shaft decreases sufficiently and the differential rotation becomes zero the second one-way clutch engages and engine braking operates. Therefore, depending on the magnitude of the differential rotation of the second one-way clutch when transitioning to the deceleration traveling state, there is a possibility that the time lag before engine braking operates will change and a driver will experience a disagreeable sensation.

The present invention has been accomplished in light of the above circumstances, and it is an object thereof to provide a vehicular power transmission device equipped with a crank type continuously variable transmission that enables the time lag before engine braking operates when the vehicle transitions to a deceleration traveling state to be made constant.

### Means for Solving the Problems

In order to attain the above object, according to a first aspect of the present invention, there is provided a vehicular power transmission device comprising an input shaft that is connected to an engine, an output shaft that is disposed in parallel to the input shaft, a swinging link that is swingably supported on the output shaft, a first one-way clutch that is disposed between the output shaft and the swinging link, and that is engaged when the swinging link swings in one direction, and that releases engagement when the swinging link swings in the other direction, an eccentric member that rotates eccentrically integrally with the input shaft, a gear shaft that is disposed coaxially with the input shaft and changes an amount of eccentricity of the eccentric member, a shift actuator that makes the gear shaft rotate relative to the input shaft, an electric motor that drives the shift actuator, a connecting rod that connects the eccentric member and the swinging link, auxiliary driving force transmission means that can transmit a driving force from the output shaft to the input shaft, and a second one-way clutch that is disposed in the auxiliary driving force transmission means and that is engaged when the rotational speed of the output shaft is at least the rotational speed of the input shaft, wherein the shift actuator comprises a first member that is connected to the input shaft, a second member that is connected to the gear shaft, a third member that is connected to the electric motor and that drives the first and second members at different rotational speeds, and engagement portions that engage with each other when the first and second members are in a predetermined phase and that are capable of transmitting rotation of the second member directly to the first member, and when the vehicle transitions from an acceleration traveling state or a constant-speed traveling state to a deceleration traveling state, the driving force of the electric motor is transmitted to the input shaft via the engagement portion so that the time taken for the second one-way clutch to switch from a non-engaged state to an engaged state coincides with a preset predetermined time.

Further, according to a second aspect of the present invention, in addition to the first aspect, when the differential rotation of the second one-way clutch is a predetermined value or greater, rotation of the input shaft is braked by the driving force of the electric motor.

Furthermore, according to a third aspect of the present invention, in addition to the second aspect, the device comprises a generator connected to the engine, the electric motor being driven with power generated by the generator.

Moreover, according to a fourth aspect of the present invention, in addition to the second or third aspect, the larger the differential rotation of the second one-way clutch, the further the driving force of the electric motor is increased.

Further, according to a fifth aspect of the present invention, in addition to any one of the first to fourth aspects, when the differential rotation of the second one-way clutch is less than a predetermined value, rotation of the input shaft is assisted by the driving force of the electric motor or the driving force of the generator operating as a motor.

The first output shaft 13 of the embodiment corresponds to the output shaft of the present invention, an eccentric disk 19 of an embodiment corresponds to the eccentric member of the present invention, a sun gear 28 of the embodiment corresponds to the third member of the present invention, a first ring gear 30 of the embodiment corresponds to the first member of the present invention, a second ring gear 31 of the embodiment corresponds to the second member of the present invention, and a first engagement portion 43a and a second engagement portion 44a of the embodiment correspond to the engagement portion of the present invention.

### Effects of the Invention

In accordance with the first aspect of the present invention, when the input shaft connected to the engine rotates, the eccentric member rotates eccentrically integrally with the input shaft, the connecting rod having one end connected to the eccentric member moves back-and-forth, and the swinging link connected to the other end of the connecting rod swings back-and-forth. When the swinging link swings in one direction the first one-way clutch is engaged, and when the swinging link swings in the other direction the first one-way clutch releases the engagement, rotation of the input shaft thus being changed in speed and transmitted to the output shaft. When the shift actuator is driven by the electric motor to thus rotate the gear shaft relative to the input shaft, the amount of eccentricity of the eccentric member changes, the back-and-forth stroke of the connecting rod changes, and the gear ratio of the power transmission device is changed.

When the third member of the shift actuator is rotatingly driven by the electric motor, the first member connected to the input shaft and the second member connected to the gear shaft are driven at different rotational speeds; when the relative rotational angle between the first and second members becomes a predetermined value or greater, the engagement portion is engaged, and the input shaft and the gear shaft are rotatingly driven by the driving force of the electric motor.

When the vehicle transitions from the acceleration traveling state or the constant-speed traveling state to the deceleration traveling state, the second one-way clutch is in a non-engaged state due to it having differential rotation, but when the differential rotation becomes zero, the second one-way clutch is engaged to thus transmit to the engine the driving force that has been transmitted back via the auxiliary driving force transmission means, thereby enabling engine braking to be operated. In this process, although a difference occurs in the time lag before the second one-way clutch is engaged depending on the magnitude of the differential rotation, since the driving force of the electric motor is transmitted to the input shaft via the engagement portion so that the time taken for the second one-way clutch to switch from a non-engaged state to an engaged state, that is, the time taken for the differential rotation to become zero, coincides with the preset predetermined time, it is possible to make the time lag before engine braking operates uniform, thus eliminating any disagreeable sensation for a driver.

Furthermore, in accordance with the second aspect of the present invention, since, when the differential rotation of the second one-way clutch is a predetermined value or greater, rotation of the input shaft is braked by the driving force of the electric motor, it is possible to prevent engagement of the second one-way clutch from being delayed.

Moreover, in accordance with the third aspect of the present invention, since there is provided the generator connected to the engine, and the electric motor is driven with power generated by the generator, rotation of the input shaft can be braked effectively by means of both the load of the generator and the driving force of the electric motor.

Furthermore, in accordance with the fourth aspect of the present invention, since the driving force of the electric motor is increased in response to an increase in the differential rotation of the second one-way clutch, the longer that engagement of the second one-way clutch is delayed due to a large differential rotation, the more strongly rotation of the input shaft is braked by the driving force of the electric motor, thus enabling the time lag before the second one-way clutch is engaged to be made constant.

Moreover, in accordance with the fifth aspect of the present invention, since, when the differential rotation of the second one-way clutch is less than a predetermined value, rotation of the input shaft is assisted by the driving force of the electric motor or the driving force of the generator operating as a motor, it is possible to prevent the second one-way clutch from engaging too early.

### BRIEF DESCRIPTION OF DRAWINGS

FIG. 1 is an overall perspective view of a continuously variable transmission.

### FIRST EMBODIMENT

FIG. 2 is a partially cutaway perspective view of an essential part of the continuously variable transmission. (first embodiment)

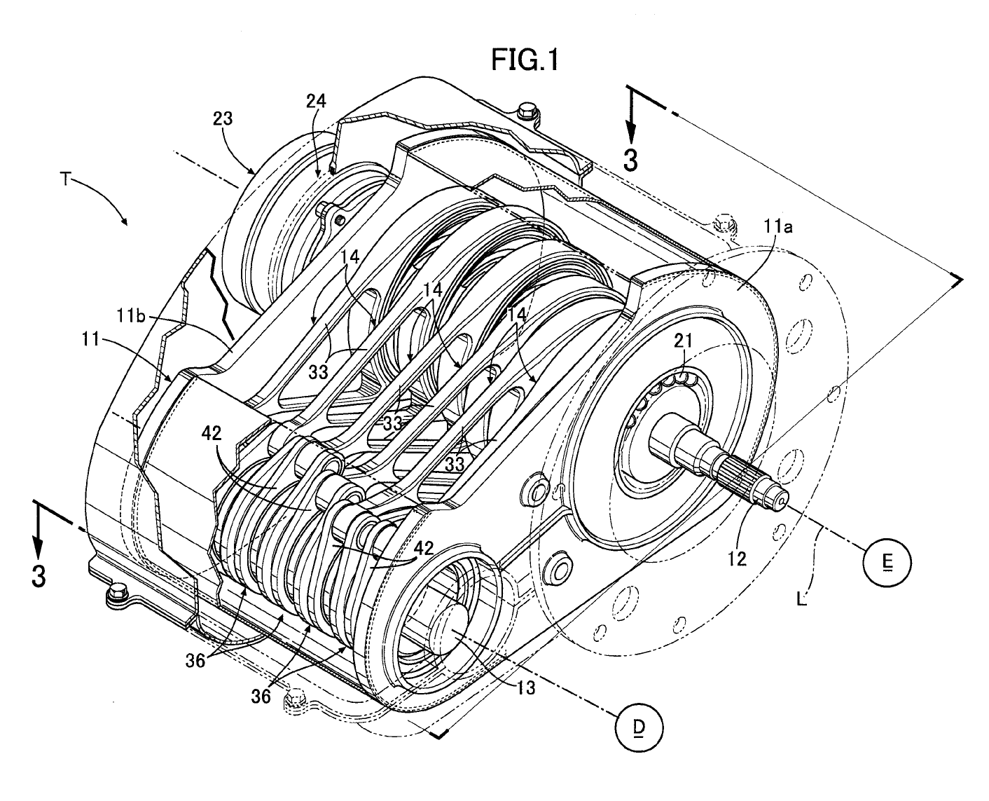

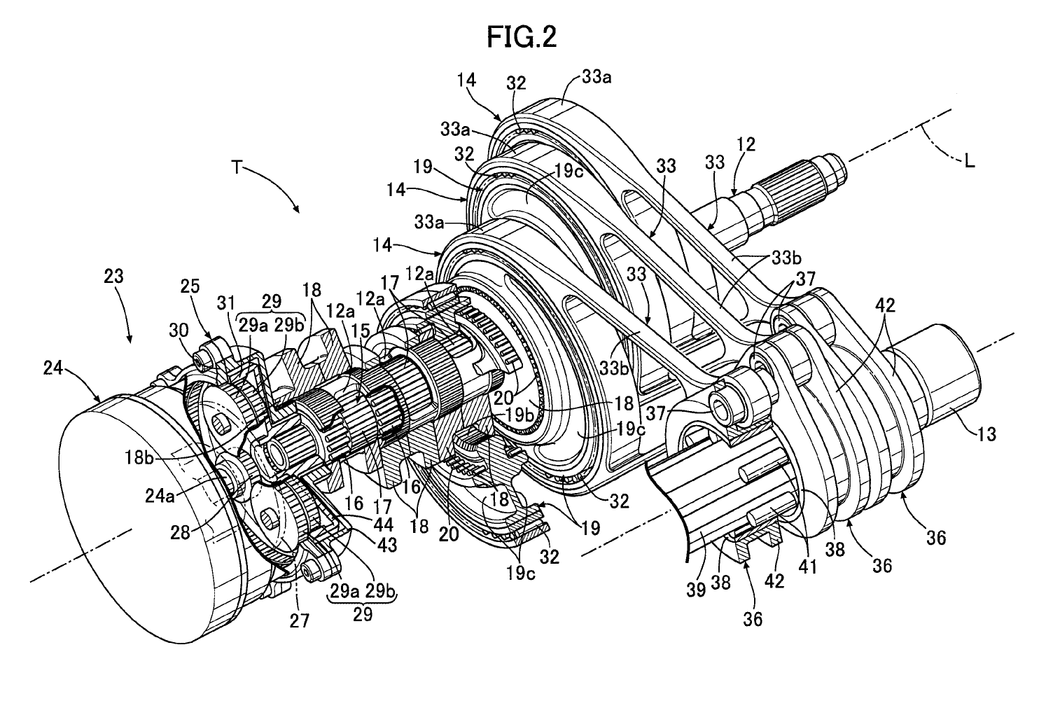

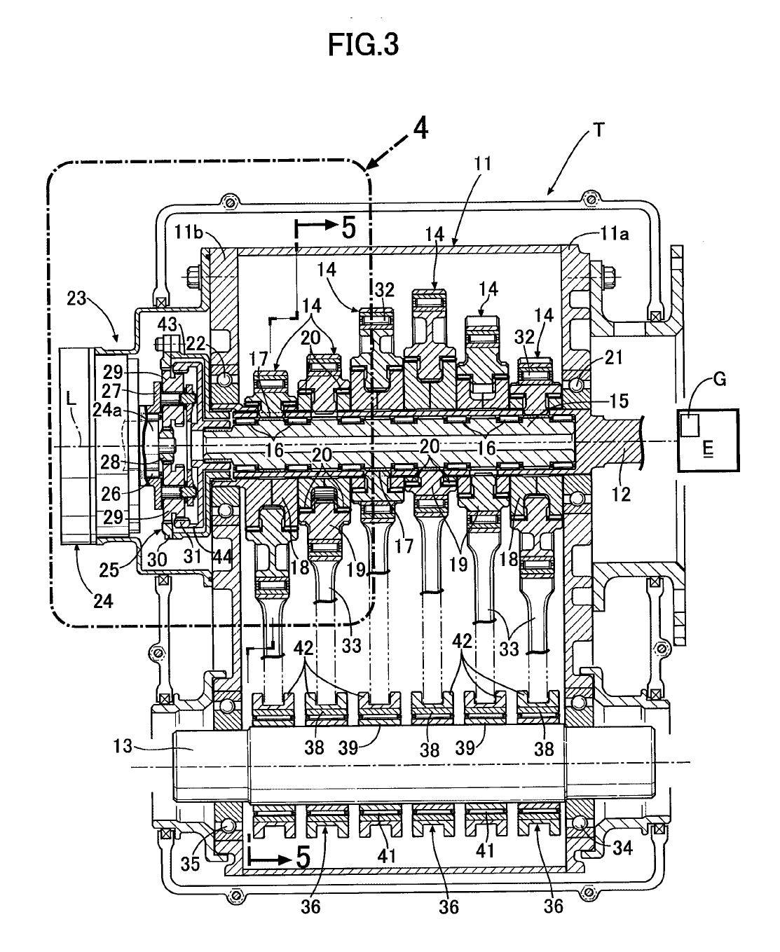

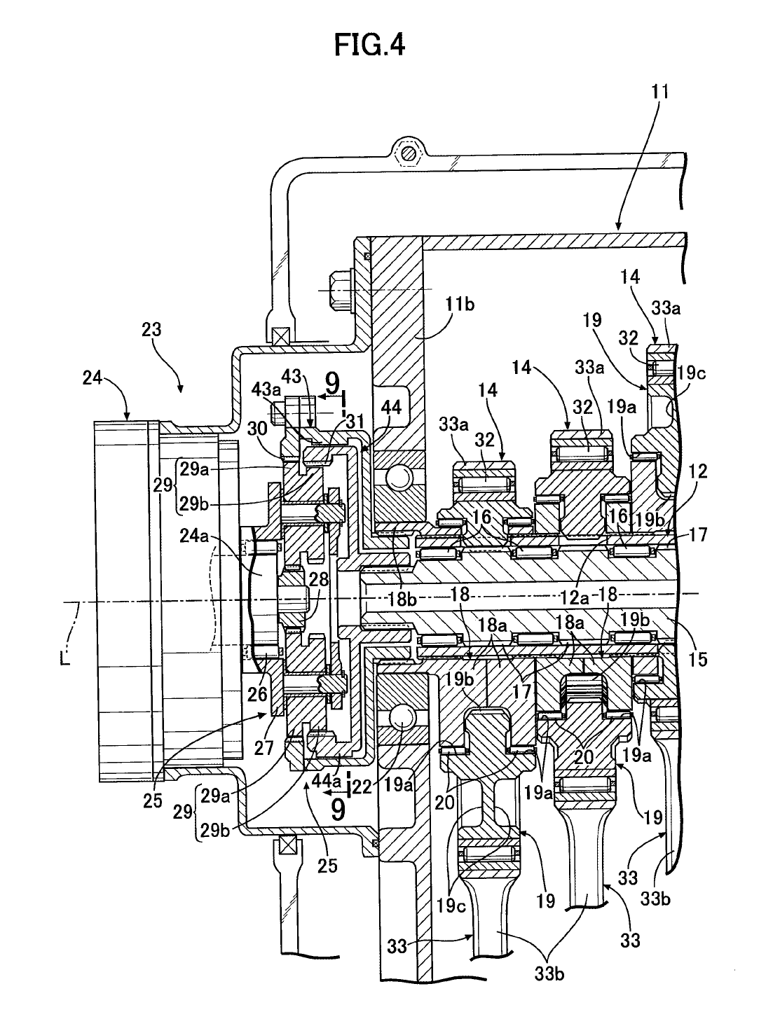

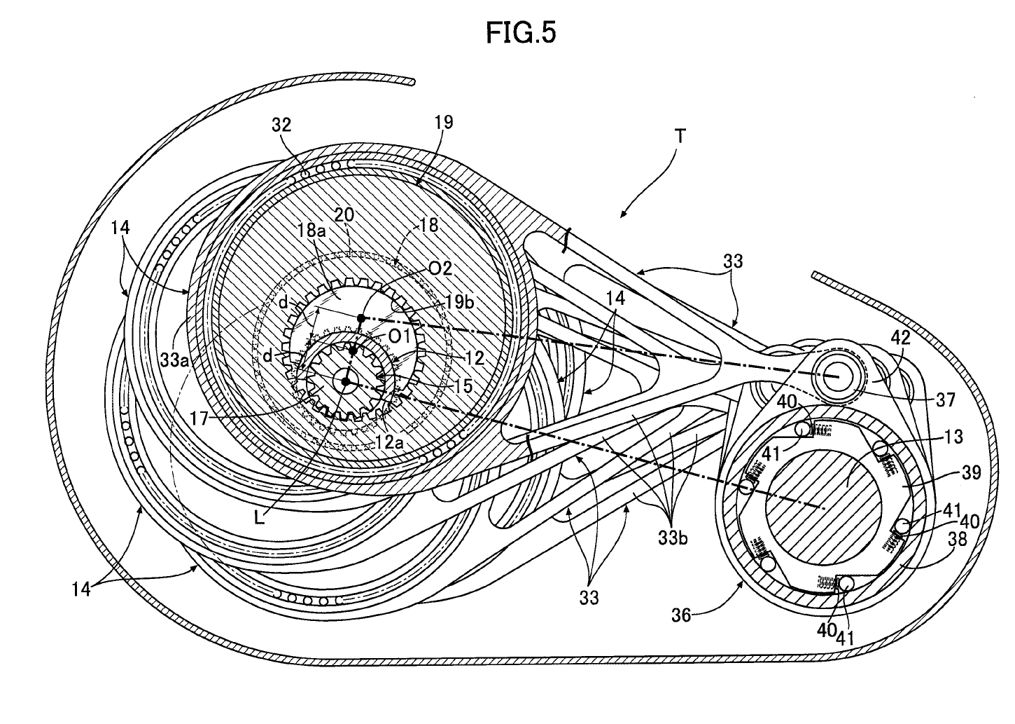

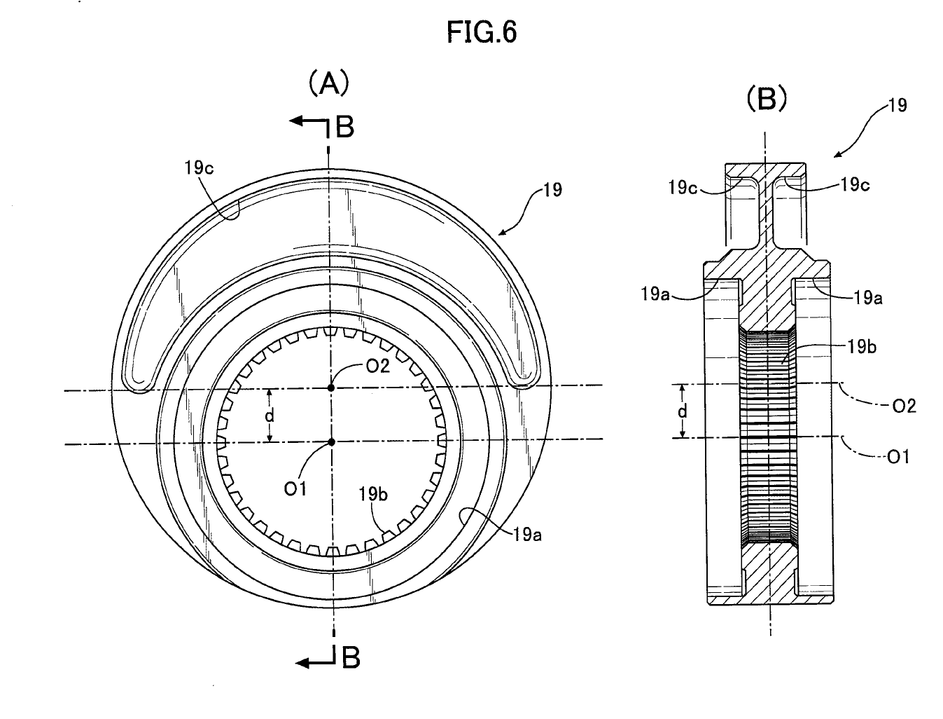

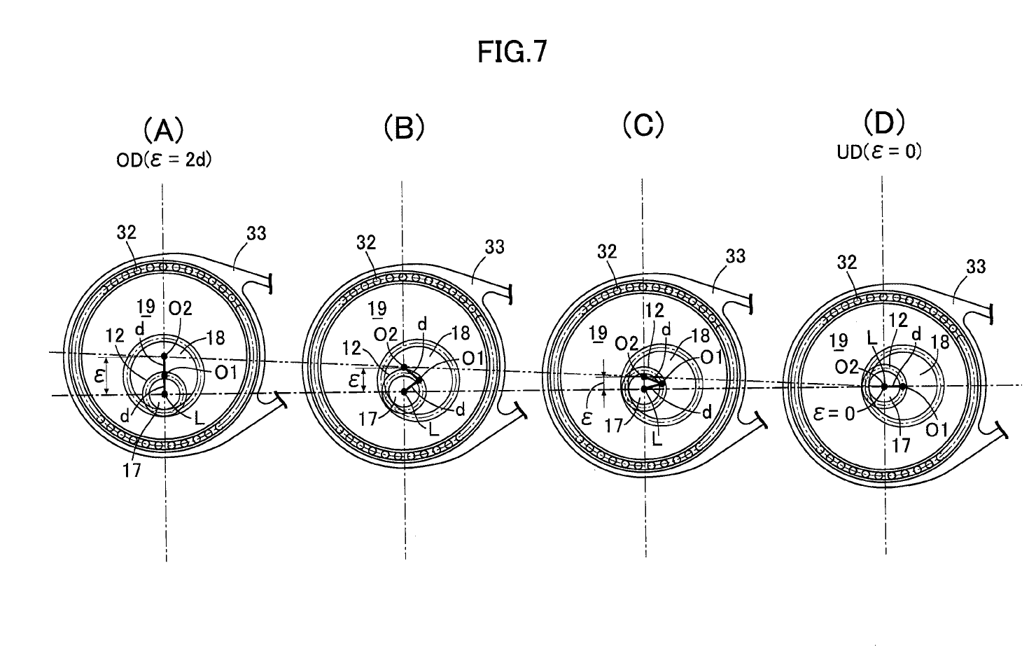

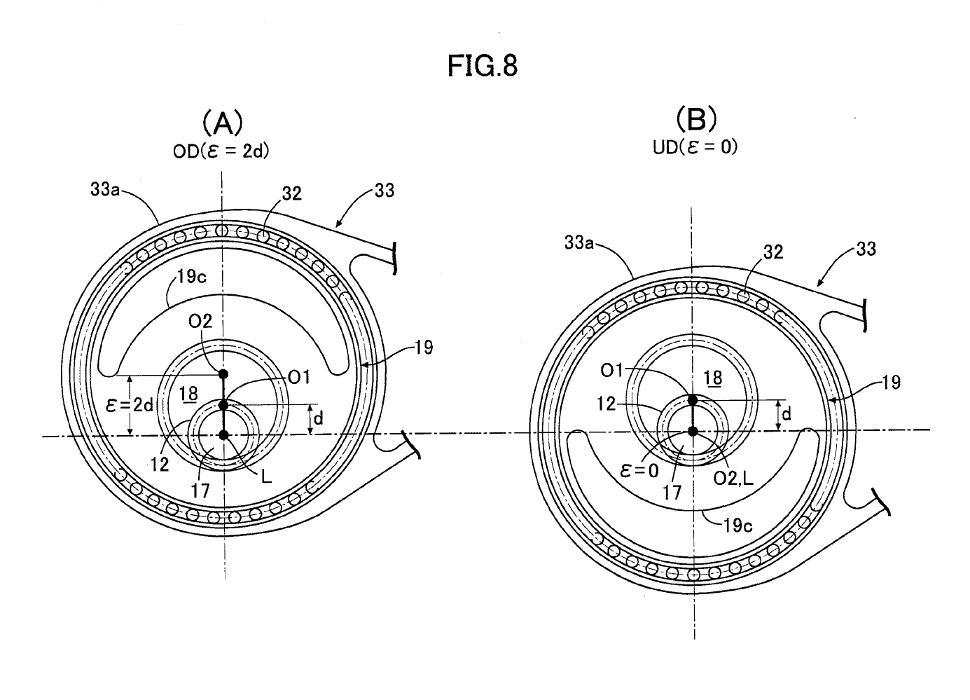

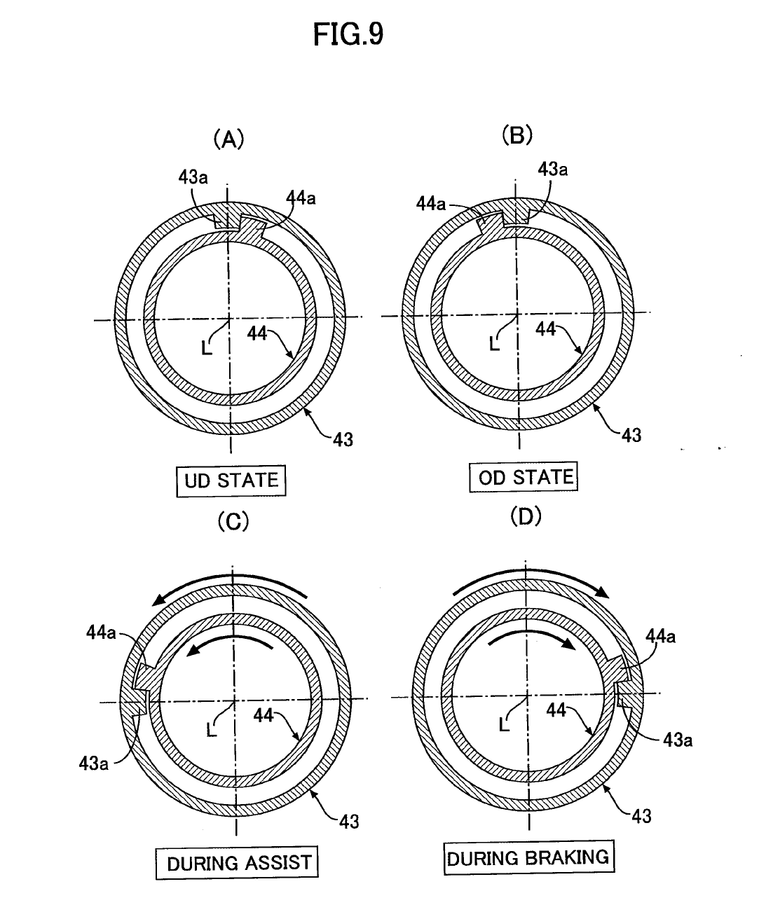

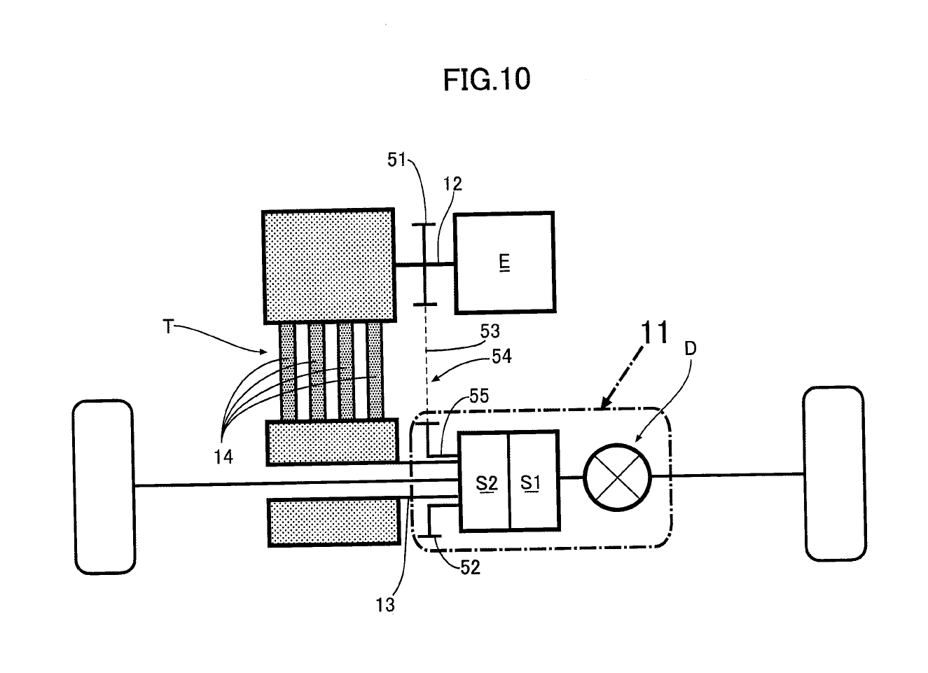

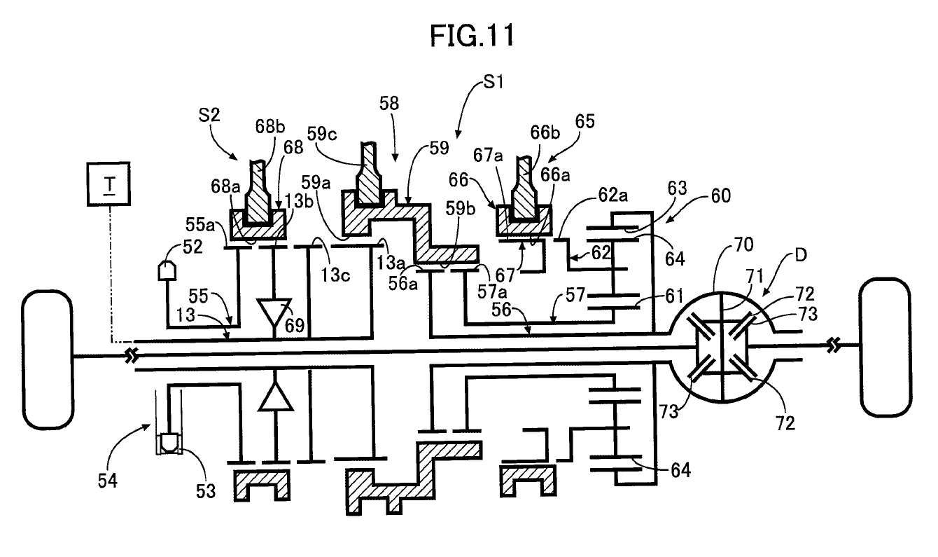

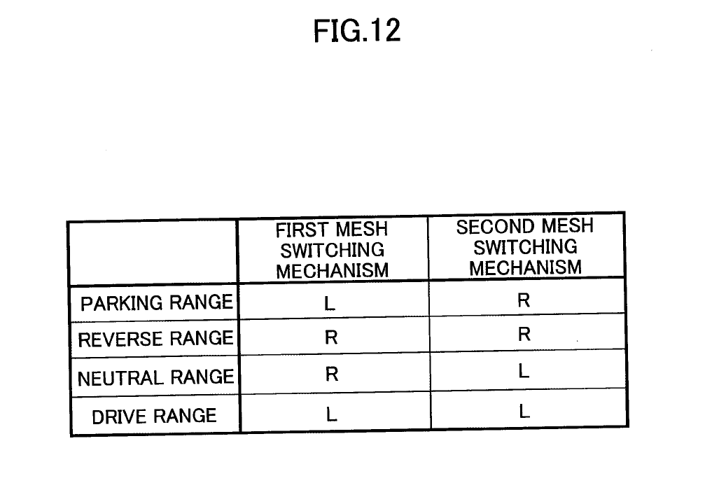

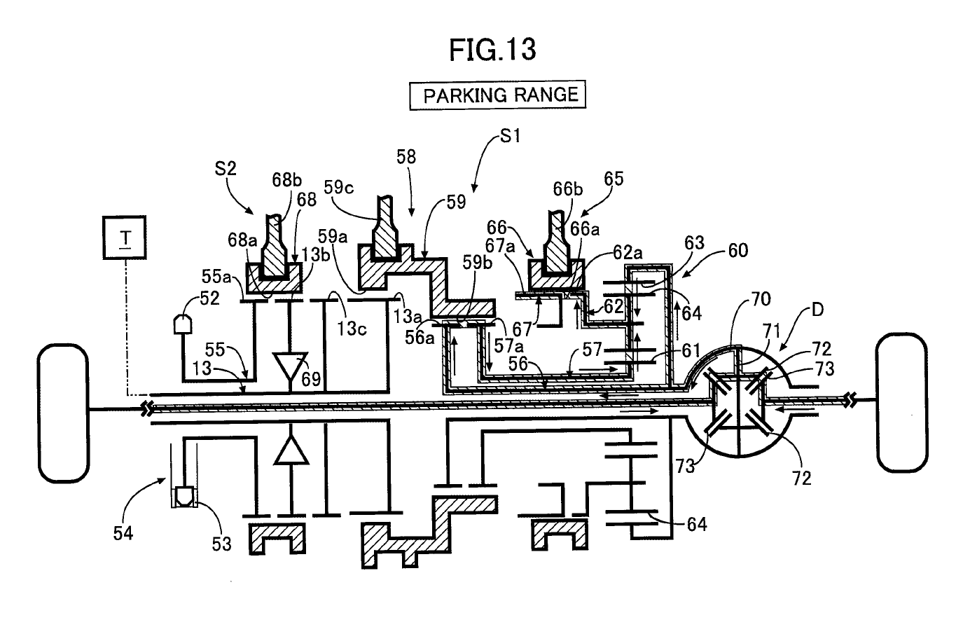

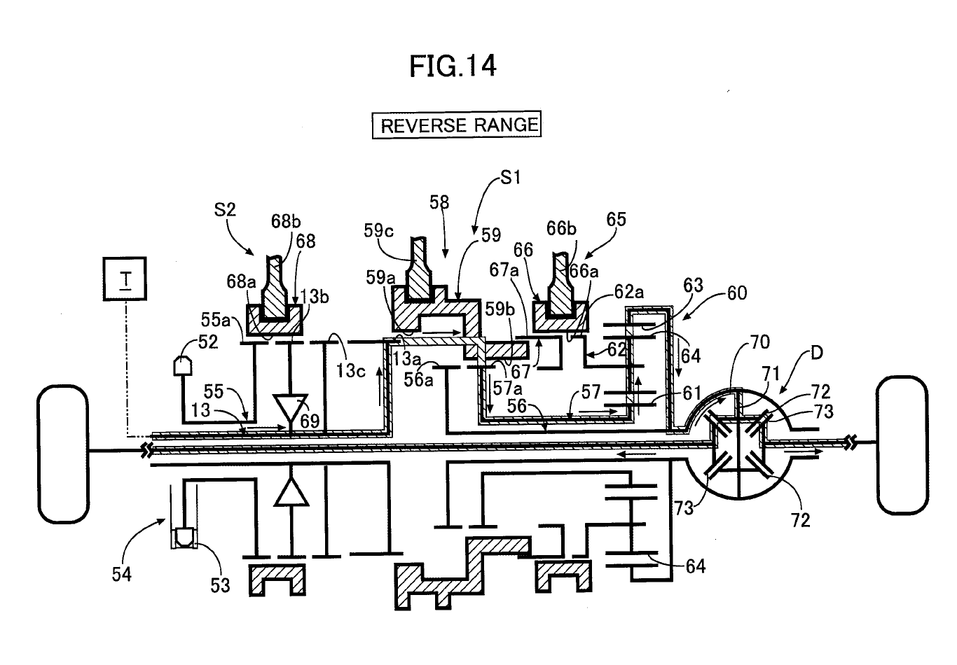

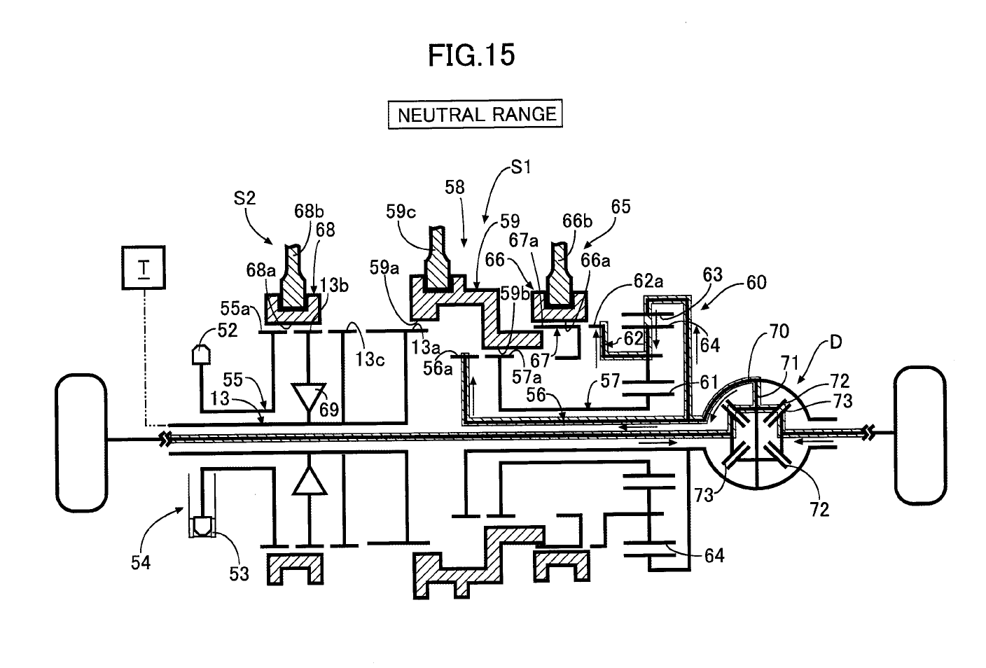

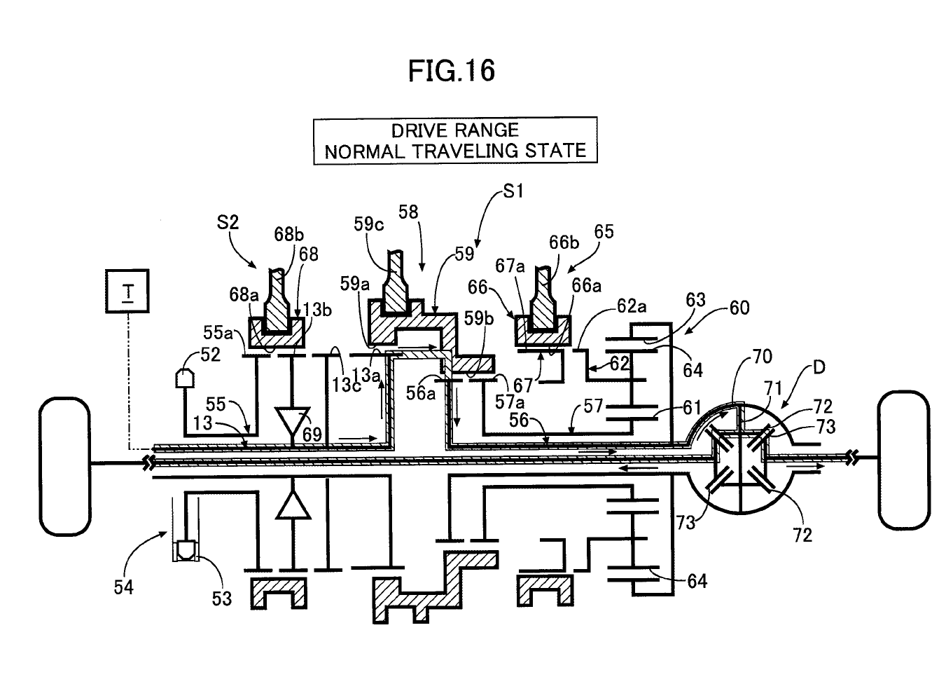

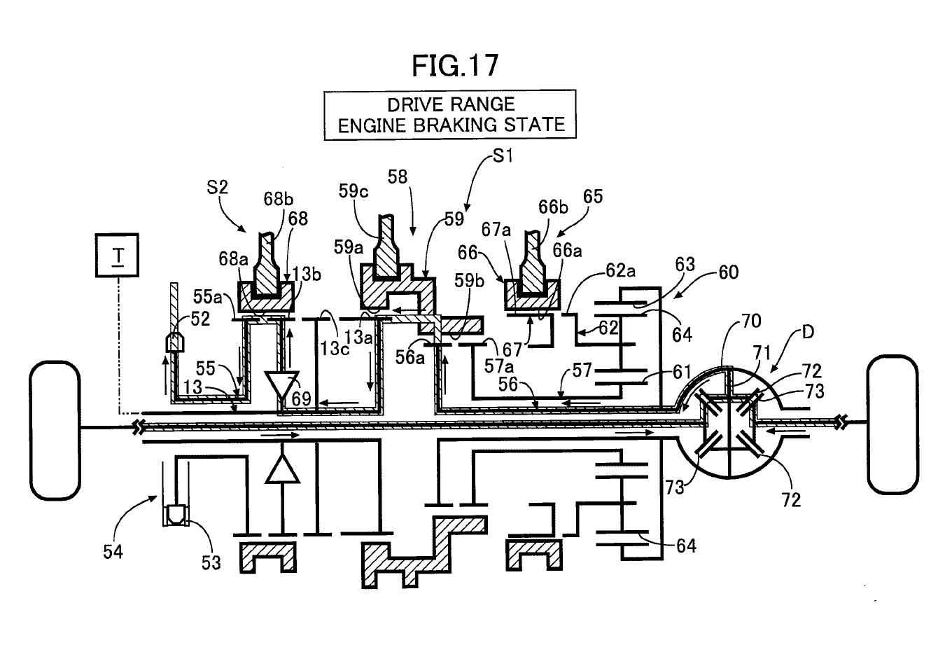

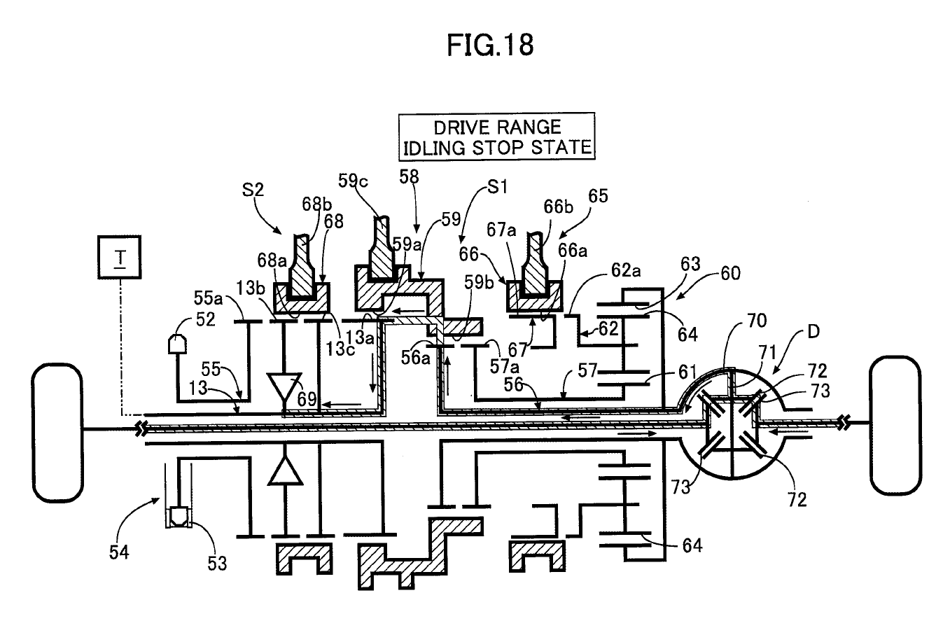

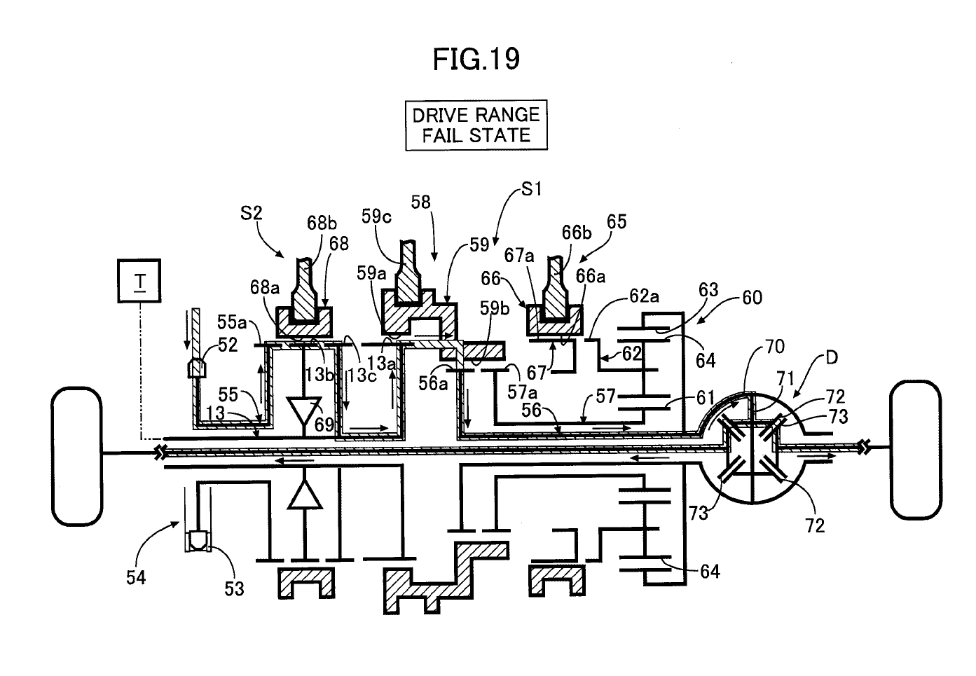

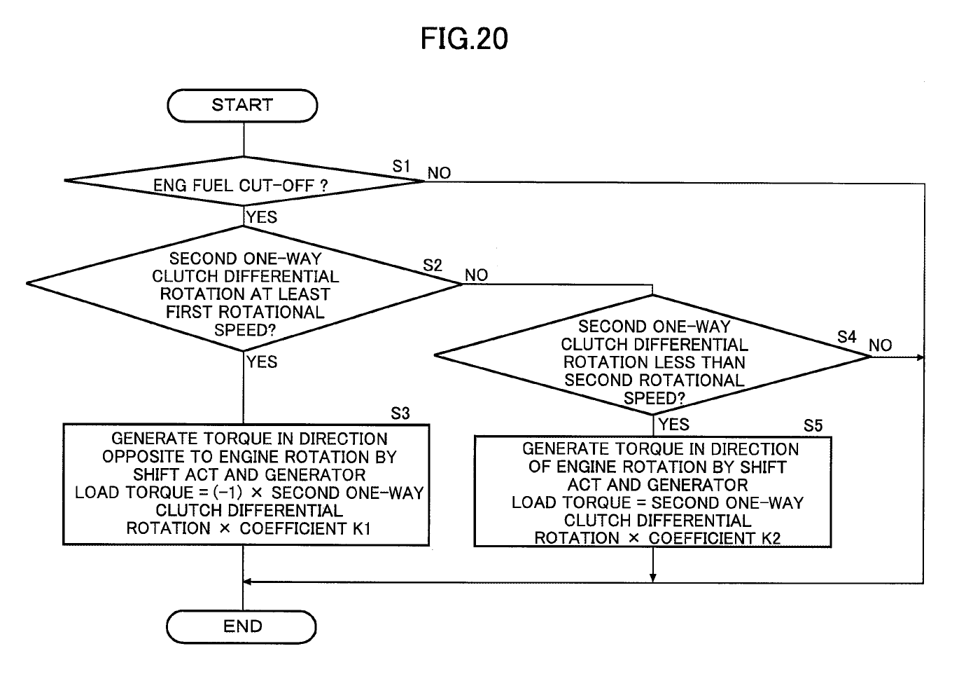

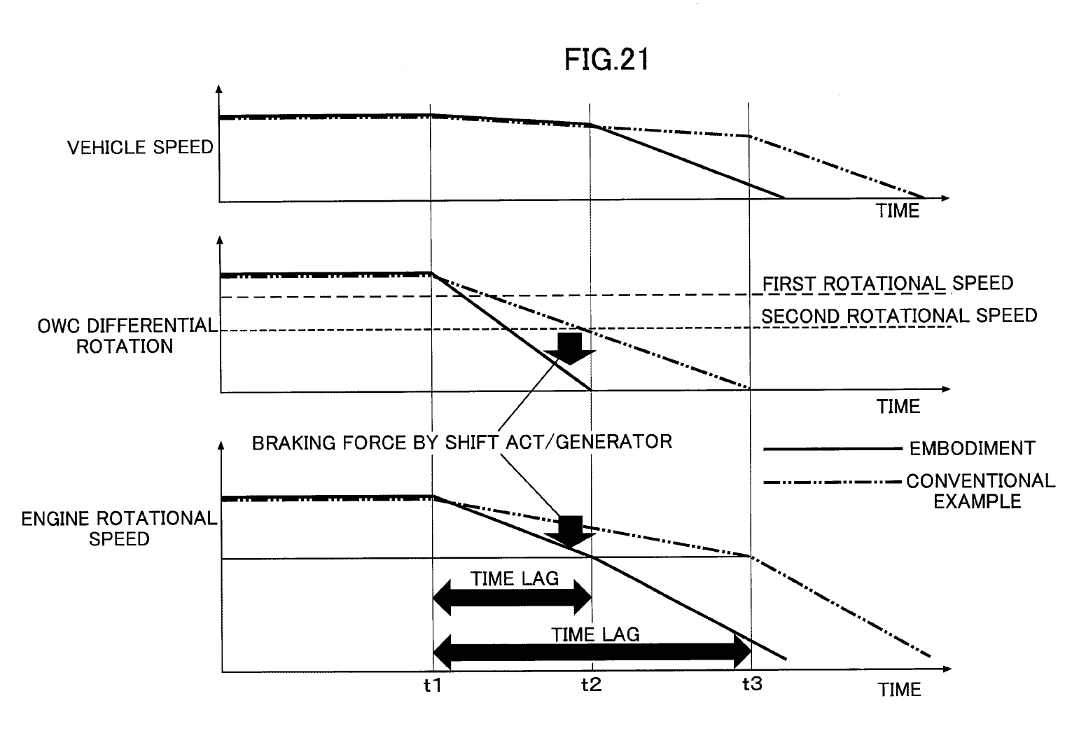

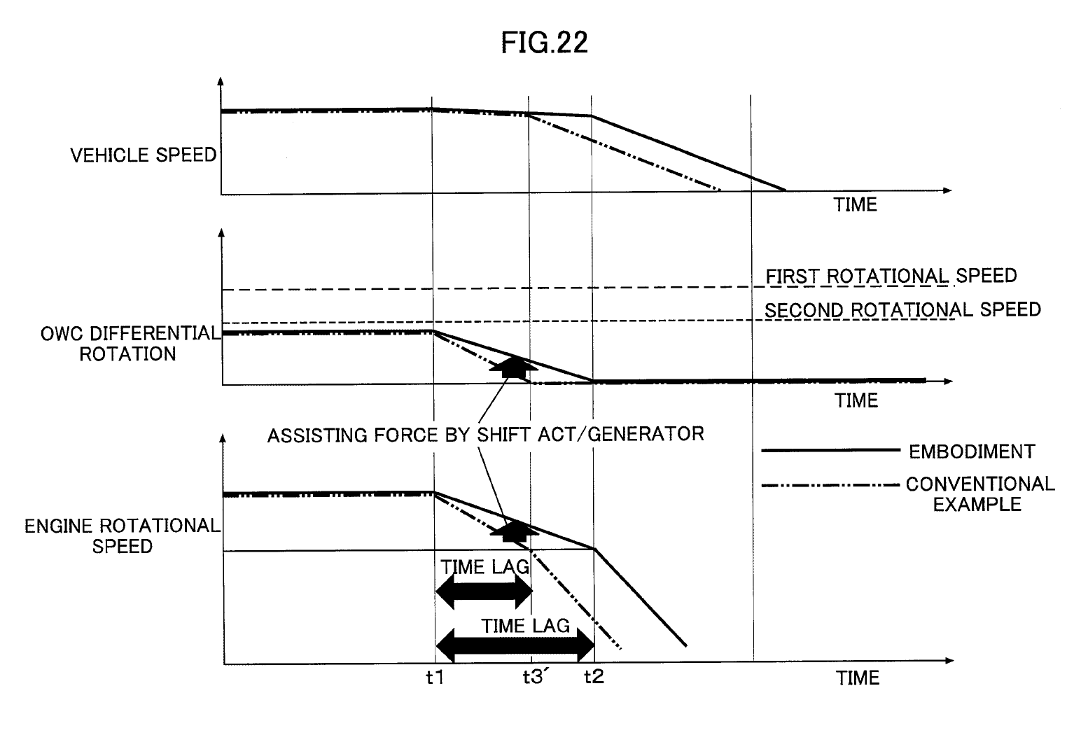

FIG. 3 is a sectional view along line 3-3 in FIG. 1. (first embodiment)

FIG. 4 is an enlarged view of part 4 in FIG. 3. (first embodiment)

FIG. 5 is a sectional view along line 5-5 in FIG. 3. (first embodiment)

FIG. 6 is a diagram showing the shape of an eccentric disk. (first embodiment)

FIG. 7 is a diagram showing the relationship between the amount of eccentricity of the eccentric disk and gear ratio. (first embodiment)

FIG. 8 is a diagram showing the state of the eccentric disk in a OD gear ratio and an UD gear ratio. (first embodiment)

FIG. 9 is a sectional view along line 9-9 in FIG. 4. (first embodiment)

FIG. 10 is a skeleton diagram of a vehicular power transmission device. (first embodiment)

FIG. 11 is a detailed diagram of part 11 in FIG. 10. (first embodiment)

FIG. 12 is a table of engagement of first and second mesh switching mechanisms. (first embodiment)

FIG. 13 is a torque flow diagram for a parking range. (first embodiment)

FIG. 14 is a torque flow diagram for a reverse range. (first embodiment)

FIG. 15 is a torque flow diagram for a neutral range. (first embodiment)

FIG. 16 is a torque flow diagram for a drive range (normal traveling state). (first embodiment)

FIG. 17 is a torque flow diagram for a drive range (engine braking state). (first embodiment)

FIG. 18 is a torque flow diagram for a drive range (idling stop state). (first embodiment)

FIG. 19 is a torque flow diagram for a drive range (fail state). (first embodiment)

FIG. 20 is a flowchart of engine braking control. (first embodiment)

FIG. 21 is a time chart of engine braking control (at time of high differential rotation). (first embodiment)

FIG. 22 is a time chart of engine braking control (at time of low differential rotation). (first embodiment)

### EXPLANATION OF REFERENCE NUMERALS AND SYMBOLS

12 Input shaft
13 First output shaft (output shaft)
15 Gear shaft
19 Eccentric disk (eccentric member)
23 Shift actuator
24 Electric motor
28 Sun gear (third member)
30 First ring gear (first member)
31 Second ring gear (second member)
33 Connecting rod
36 First one-way clutch
42 Swinging link
43a First engagement portion (engagement portion)
44a Second engagement portion (engagement portion)
54 Auxiliary driving force transmission means
69 Second one-way clutch
E Engine
G Generator

### MODE FOR CARRYING OUT THE INVENTION

An embodiment of the present invention is explained below by reference to FIG. 1 to FIG. 22.

### First Embodiment

As shown in FIG. 1 to FIG. 5, an input shaft 12 and a first output shaft 13 are supported on a pair of side walls 11a and 11b of a transmission case 11 of a continuously variable transmission T for a vehicular power transmission device so as to be parallel to each other, and rotation of the input shaft 12, which is connected to an engine E, is transmitted to a driven wheel via six transmission units 14, the first output shaft 13, and a differential gear D. Provided on the engine E so as to be connected to a crankshaft thereof is a generator G (see FIG. 3). The generator G is driven by means of the driving force of the engine E or the driving force transmitted back from the driven wheel and generates power, the power thus generated being used for charging a 12 volt battery, which is not illustrated, but when engine braking, which is described later, operates, the generator G functions as a motor, thus increasing the rotational speed of the engine E.

A transmission shaft 15 having a common axis L with the input shaft 12 is relatively rotatably fitted into the interior of the input shaft 12, which is hollow, via seven needle bearings 16. Since the structures of the six transmission units 14 are substantially identical, the structure of one transmission unit 14 is explained below as being representative thereof.

The transmission unit 14 includes a pinion 17 provided on an outer peripheral face of the transmission shaft 15, and this pinion 17 is exposed through an opening 12a formed in the input shaft 12. A disk-shaped eccentric cam 18, which is split into two in the axis L direction, is spline-joined to the outer periphery of the input shaft 12 so as to sandwich the pinion 17. A center O1 of the eccentric cam 18 is eccentric to the axis L of the input shaft 12 only by a distance d. The phases in the direction of eccentricity of the six eccentric cams 18 of the six transmission units 14 are displaced from each other by 60°.

A pair of eccentric recess portions 19a and 19a formed in opposite end faces in the axis L direction of a disk-shaped eccentric disk 19 are rotatably supported on an outer peripheral face of the eccentric cam 18 via a pair of needle bearings 20 and 20. The center O1 of the eccentric recess portions 19a and 19a (that is, the center O1 of the eccentric cam 18) is displaced only by the distance d with respect to a center O2 of the eccentric disk 19. That is, the distance d between the axis L of the input shaft 12 and the center O1 of the eccentric cam 18 is identical to the distance d between the center O1 of the eccentric cam 18 and the center O2 of the eccentric disk 19.

A pair of crescent-shaped guide portions 18a and 18a, which are coaxial with the center O1 of the eccentric cam 18, are provided on split faces of the eccentric cam 18, which is split into two in the axis L direction, and the extremities of teeth of a ring gear 19b formed so as to provide communication between bottom parts of the pair of eccentric recess portions 19a and 19a of the eccentric disk 19 abut slidably against outer peripheral faces of the guide portions 18a and 18a of the eccentric cam 18. The pinion 17 of the transmission shaft 15 meshes with the ring gear 19b of the eccentric disk 19 through the opening 12a of the input shaft 12.

The right end side of the input shaft 12 is directly supported on the right-hand side wall 11a of the transmission case 11 via a ball bearing 21. Furthermore, a tubular portion 18b provided integrally with one eccentric cam 18 positioned on the left end side of the input shaft 12 is supported on the left-hand side wall 11b of the transmission case 11 via a ball bearing 22, and the left end side of the input shaft 12 spline-joined to the inner periphery of the eccentric cam 18 is indirectly supported on the transmission case 11.

A transmission actuator 23 that varies the gear ratio of the continuously variable transmission T by rotating the transmission shaft 15 relative to the input shaft 12 includes an electric motor 24 supported on the transmission case 11 so that a motor shaft 24a is coaxial with the axis L, and a planetary gear mechanism 25 connected to the electric motor 24. The planetary gear mechanism 25 includes a carrier 27 rotatably supported on the electric motor 24 via a needle bearing 26, a sun gear 28 fixed to the motor shaft 24a, a plurality of double pinions 29 rotatably supported on the carrier 27, a first ring gear 30 provided on a first connecting member 43 spline-joined to the shaft end of the hollow input shaft 12 (strictly speaking, the tubular portion 18b of said one eccentric cam 18), and a second ring gear 31 provided on a second connecting member 44 spline-joined to the shaft end of the transmission shaft 15. Each double pinion 29 includes a large diameter first pinion 29a and a small diameter second pinion 29b, the first pinion 29a meshing with the sun gear 28 and the first ring gear 30, and the second pinion 29b meshing with the second ring gear 31.

An annular outer peripheral part of the first connecting member 43 and an annular outer peripheral part of the second connecting member 44 oppose each other in the radial direction (see FIG. 4 and FIG. 9), a first engagement portion 43a is radially inwardly projectingly provided on an inner peripheral face of the first connecting member 43 on the radially outer side, and a second engagement portion 44a is radially outwardly projectingly provided on an outer peripheral face of the second connecting member 44 on the radially inner side. When the amount of eccentricity of the eccentric disk 19 of the transmission unit 14 is zero, that is, when the gear ratio of the continuously variable transmission T is UD, the second engagement portion 44a abuts against the first engagement portion 43a from one side (see FIG. 9 (A)). When the amount of eccentricity of the eccentric disk 19 of the transmission unit 14 increases from zero and the gear ratio of the continuously variable transmission T changes from UD toward OD, the second engagement portion 44a undergoes relative rotation in the clockwise direction in the figure with respect to the first engagement portion 43a, and when the gear ratio of the continuously variable transmission T reaches OD, the second engagement portion 44a abuts against the first engagement portion 43a from the other side (see FIG. 9 (B)).

An annular portion 33a on one end side of a connecting rod 33 is relatively rotatably supported on the outer periphery of the eccentric disk 19 via a roller bearing 32.

The first output shaft 13 is supported on the pair of side walls 11a and 11b of the transmission case 11 by means of a pair of ball bearings 34 and 35, a swinging link 42 is supported on the outer periphery of the first output shaft 13 via a first one-way clutch 36, and the extremity of the swinging link 42 is pivotably supported on the extremity of a rod portion 33b of the connecting rod 33 via a pin 37. The first one-way clutch 36 includes a ring-shaped outer member 38 press fitted into the inner periphery of the swinging link 42, an inner member 39 disposed in the interior of the outer member 38 and fixed to the first output shaft 13, and a plurality of rollers 41 disposed in a wedge-shaped space formed between an arc face on the inner periphery of the outer member 38 and a flat face on the outer periphery of the inner member 39 and urged by a plurality of springs 40.

As shown in FIG. 6 and FIG. 8, the center O1 of the eccentric recess portions 19a and 19a (that is, the center O1 of the eccentric cam 18) is displaced by the distance d with respect to the center O2 of the eccentric disk 19, the gap between the outer periphery of the eccentric disk 19 and the inner periphery of the eccentric recess portions 19a and 19a is non-uniform in the circumferential direction, and crescent-shaped cutout recess portions 19c and 19c are formed in a section where the gap is large.

The operation of one transmission unit 14 of the continuously variable transmission T is now explained.

As is clear from FIG. 5 and FIG. 7 (A) to FIG. 7 (D), if the center O2 of the eccentric disk 19 is eccentric with respect to the axis L of the input shaft 12, when the input shaft 12 is rotated by the engine E, the annular portion 33a of the connecting rod 33 rotates eccentrically around the axis L, and the rod portion 33b of the connecting rod 33 moves back-and-forth.

As a result, when the connecting rod 33 is pulled leftward in the figure in the process of moving back-and-forth, the rollers 41 urged by the springs 40 bite into the wedge-shaped spaces between the outer member 38 and the inner member 39; due to the outer member 38 and the inner member 39 being joined via the rollers 41, the first one-way clutch 36 is engaged, and movement of the connecting rod 33 is transmitted to the first output shaft 13. On the other hand, when the connecting rod 33 is pushed rightward in the figure during the process of moving back-and-forth, the rollers 41 are pushed out from the wedge-shaped spaces between the outer member 38 and the inner member 39 while compressing the springs 40; due to the outer member 38 and the inner member 39 slipping relative to each other, engagement of the first one-way clutch 36 is released, and movement of the connecting rod 33 is not transmitted to the first output shaft 13.

In this way, since, while the input shaft 12 rotates once, rotation of the input shaft 12 is transmitted to the first output shaft 13 only for a predetermined time, if the input shaft 12 rotates continuously, the first output shaft 13 rotates intermittently. Since the phases in the direction of eccentricity of the eccentric disks 19 of the six transmission units 14 are displaced from each other by 60°, the six transmission units 14 transmit rotation of the input shaft 12 to the first output shaft 13 in turn, and the first output shaft 13 rotates continuously.

In this process, the larger the amount of eccentricity ε of the eccentric disk 19, the larger the back-and-forth stroke of the connecting rod 33 becomes, the rotational angle of the first output shaft 13 per cycle increases, and the gear ratio of the continuously variable transmission T becomes small. On the other hand, the smaller the amount of eccentricity ε of the eccentric disk 19, the smaller the back-and-forth stroke of the connecting rod 33 becomes, the rotational angle of the first output shaft 13 per cycle decreases, and the gear ratio of the continuously variable transmission T becomes large. When the amount of eccentricity ε of the eccentric disk 19 becomes zero, even if the input shaft 12 rotates, the connecting rod 33 stops moving, the first output shaft 13 therefore does not rotate, and the gear ratio of the continuously variable transmission T becomes UD, which is the maximum (infinite).

When the transmission shaft 15 does not rotate relative to the input shaft 12, that is, when the input shaft 12 and the transmission shaft 15 rotate at the same speed, the gear ratio of the continuously variable transmission T is held constant. In order to rotate the input shaft 12 and the transmission shaft 15 at the same speed, the electric motor 24 may be rotated at the same speed as that of the input shaft 12. The reason therefor is that the first ring gear 30 of the planetary gear mechanism 25 is connected to the input shaft 12 and rotates at the same speed as that of the input shaft 12; when the electric motor 24 is driven at the same speed as above, the sun gear 28 and the first ring gear 30 rotate at the same speed, the planetary gear mechanism 25 thereby attains a locked state, and the entirety rotates as a unit. As a result, the input shaft 12 and the transmission shaft 15 connected to the first ring gear 30 and the second ring gear 31, which rotate as a unit, are integrated and rotate at the same speed without rotating relative to each other.

When the rotational speed of the electric motor 24 is increased or decreased relative to the rotational speed of the input shaft 12, since the first ring gear 30 joined to the input shaft 12 and the sun gear 28 connected to the electric motor 24 rotate relative to each other, the carrier 27 rotates relative to the first ring gear 30. In this process, since the gear ratio of the first ring gear 30 and the first pinion 29a, which mesh with each other, is slightly different from the gear ratio of the second ring gear 31 and the second pinion 29b, which mesh with each other, the input shaft 12 connected to the first ring gear 30 rotates relative to the transmission shaft 15 connected to the second ring gear 31.

In this way, when the transmission shaft 15 rotates relative to the input shaft 12, the eccentric recess portions 19a and 19a of the eccentric disk 19 having the ring gear 19b meshing with the pinion 17 of each transmission unit 14 are guided by the guide portions 18a and 18a of the eccentric cam 18, which is integral with the input shaft 12, and rotate, and the amount of eccentricity ε of the center O2 of the eccentric disk 19 with respect to the axis L of the input shaft 12 changes.

FIG. 7 (A) shows a state in which the gear ratio is a minimum (gear ratio:OD); here, the amount of eccentricity ε of the center O2 of the eccentric disk 19 with respect to the axis L of the input shaft 12 becomes a maximum value of 2d, which is equal to the sum of the distance d from the axis L of the input shaft 12 to the center O1 of the eccentric cam 18 and the distance d from the center O1 of the eccentric cam 18 to the center O2 of the eccentric disk 19. When the transmission shaft 15 rotates relative to the input shaft 12, the eccentric disk 19 rotates relative to the eccentric cam 18, which is integral with the input shaft 12, as shown in FIG. 7 (B) and FIG. 7 (C) the amount of eccentricity ε of the center O2 of the eccentric disk 19 with respect to the axis L of the input shaft 12 gradually decreases from a maximum value of 2d, and the gear ratio increases. When the transmission shaft 15 rotates further relative to the input shaft 12, the eccentric disk 19 rotates further relative to the eccentric cam 18, which is integral with the input shaft 12, as shown in FIG. 7 (D) the center O2 of the eccentric disk 19 finally overlaps the axis L of the input shaft 12, the amount of eccentricity ε becomes zero, the gear ratio attains a maximum (infinite) state (gear ratio:UD), and power transmission to the first output shaft 13 is cut off.

As schematically shown in FIG. 10, the vehicular power transmission device further includes a first power transmission switching mechanism S1 and a second power transmission switching mechanism S2. The first power transmission switching mechanism S1 can switch between a parking range, a reverse range, a neutral range, and a drive range. The second power transmission switching mechanism S2 can switch between a normal traveling/engine braking state, an idling stop state, and a fail state. The vehicular power transmission device also includes an auxiliary power transmission path that can transmit driving force via a path that is separate from that involving the six transmission units 14 of the continuously variable transmission T. That is, a first sprocket 51 provided on the input shaft 12 on the upstream side (the engine E side) of the transmission units 14 and a second sprocket 52 provided on a transmission shaft 55 relatively rotatably fitted on the outer periphery of the first output shaft 13 on the downstream side (the differential gear D) side of the transmission units 14 are connected via an endless chain 53, the first sprocket 51, the second sprocket 52, and the endless chain 53 forming the auxiliary driving force transmission means 54.

As is clear from FIG. 11, the first power transmission switching mechanism S1 includes, in addition to the tubular first output shaft 13, which is relatively rotatably fitted around the outer periphery of an axle, a tubular second output shaft 56 that is relatively rotatably fitted around the outer periphery of the axle and a tubular third output shaft 57 that is relatively rotatably fitted around the outer periphery of the second output shaft 56. A fourth outer peripheral spline 13a is formed at the right end of the first output shaft 13, a fifth outer peripheral spline 56a is formed at the left end of the second output shaft 56, and a sixth outer peripheral spline 57a is formed at the left end of the third output shaft 57.

The fourth outer peripheral spline 13a, the fifth outer peripheral spline 56a, and the sixth outer peripheral spline 57a are aligned in the axial direction and form a first mesh switching mechanism 58, which is a dog clutch, the external diameters of the fifth outer peripheral spline 56a and the sixth outer peripheral spline 57a being equal to each other and smaller than the external diameter of the fourth outer peripheral spline 13a. A sleeve 59 of the first mesh switching mechanism 58 includes a second inner peripheral spline 59a that has a large external diameter and a third inner peripheral spline 59b that has a small external diameter, the second inner peripheral spline 59a always meshing with the fourth outer peripheral spline 13a, the third inner peripheral spline 59b always meshing with the sixth outer peripheral spline 57a, and the third inner peripheral spline 59b meshing with the fifth outer peripheral spline 56a only when moving leftward as shown in FIG. 11. That is, when the sleeve 59 is moved rightward by means of a fork 59c from the leftward-moved state shown in FIG. 11, meshing between the third inner peripheral spline 59b and the fifth outer peripheral spline 56a is released.

A planetary gear mechanism 60 includes a sun gear 61 as a first element, a carrier 62 as a third element, a ring gear 63 as a second element, and a plurality of pinions 64 relatively rotatably supported on the carrier 62, the pinions 64 meshing with the sun gear 61 and the ring gear 63. The sun gear 61 is connected to the right end of the third output shaft 57, and the ring gear 63 is connected to the right end of the second output shaft 56.

A first inner peripheral spline 66a formed on a sleeve 66 of a second mesh switching mechanism 65, which is a dog clutch, meshes with an outer peripheral spline 62a formed on an outer peripheral part of the carrier 62 and an outer peripheral spline 67a formed on a casing 67. Therefore, when the sleeve 66 is moved leftward by means of a fork 66b to the position shown in FIG. 11, the carrier 62 is isolated from the casing 67, and when the sleeve 66 is moved rightward by means of the fork 66b from the position shown in FIG. 11, the carrier 62 is joined to the casing 67.

The second power transmission switching mechanism S2 is provided between the transmission shaft 55 and the first output shaft 13, and includes a first outer peripheral spline 55a provided on the transmission shaft 55, a second outer peripheral spline 13b and a third outer peripheral spline 13c provided on the first output shaft 13, a sleeve 68 equipped with an inner peripheral spline 68a, a fork 68b driving the sleeve 68, and a second one-way clutch 69 disposed between the first output shaft 13 and the second outer peripheral spline 13b.

The sleeve 68 can take a leftward position in which the first outer peripheral spline 55a and the second outer peripheral spline 13b are joined, a middle position in which the first outer peripheral spline 55a, the second outer peripheral spline 13b, and the third outer peripheral spline 13c are joined, and a rightward position in which the second outer peripheral spline 13b and the third outer peripheral spline 13c are joined. Furthermore, the second one-way clutch 69 disposed between the first output shaft 13 and the second outer peripheral spline 13b is engaged when the rotational speed of the first output shaft 13 exceeds the rotational speed of the transmission shaft 55.

A differential case 70 forming an outer shell of the differential gear D is connected to the right end of the second output shaft 56. The differential gear D includes a pair of pinions 72 and 72 rotatably supported on a pinion shaft 71 fixed to the differential case 70 and side gears 73 and 73 fixedly provided on an end part of the axle and meshing with the pinions 72 and 72.

The operation of the first power transmission switching mechanism S1, which switches between the parking range, the reverse range, the neutral range, and the drive range is now explained.

As shown in FIG. 12 and FIG. 13, when the sleeve 59 of the first mesh switching mechanism 58 is moved leftward to thus integrally join the first output shaft 13, the second output shaft 56, and the third output shaft 57 and the sleeve 66 of the second mesh switching mechanism 65 is moved rightward to thus join the carrier 62 of the planetary gear mechanism 60 to the casing 67, the parking range is established.

In the parking range, the second output shaft 56 integrated with the differential case 70 is joined to the ring gear 63 of the planetary gear mechanism 60, the second output shaft 56 is connected to the sun gear 61 of the planetary gear mechanism 60 via the first mesh switching mechanism 58 and the third output shaft 57, and the carrier 62 of the planetary gear mechanism 60 is joined to the casing 67 via the second mesh switching mechanism 65. As a result, the planetary gear mechanism 60 attains a locked state, and the driven wheel connected thereto via the differential gear D is non-rotatably restrained.

As shown in FIG. 12 and FIG. 14, when the sleeve 59 of the first mesh switching mechanism 58 is moved rightward to thus join the first output shaft 13 and the third output shaft 57 and isolate the second output shaft 56, and the sleeve 66 of the second mesh switching mechanism 65 is moved rightward to thus join the carrier 62 of the planetary gear mechanism 60 to the casing 67, the reverse range is established.

In the reverse range, the driving force outputted from the continuously variable transmission T to the first output shaft 13 is transmitted to the differential case 70 via the path: first mesh switching mechanism 58→third output shaft 57→sun gear 61→carrier 62→ring gear 63, and at the same time it is reduced in speed and reversed in rotation in the planetary gear mechanism 60, thereby enabling the vehicle to travel in reverse.

As shown in FIG. 12 and FIG. 15, when the sleeve 59 of the first mesh switching mechanism 58 is moved rightward to thus join the first output shaft 13 and the third output shaft 57 and isolate the second output shaft 56, and the sleeve 66 of the second mesh switching mechanism 65 is moved leftward to thus isolate the carrier 62 of the planetary gear mechanism 60 from the casing 67, the neutral range is established.

In the neutral range, since the carrier 62 of the planetary gear mechanism 60 is isolated from the casing 67, the ring gear 63 becomes freely rotatable, and the second output shaft 56 becomes freely rotatable, the differential case 70 becomes freely rotatable, and the driven wheel attains a non-restrained state. In this state, the driving force of the engine E is transmitted from the continuously variable transmission T to the sun gear 61 via the path: first output shaft 13→first mesh switching mechanism 58→third output shaft 57, but since the carrier 62 is not restrained, the planetary gear mechanism 60 idles, and the driving force is not transmitted to the differential gear D.

As shown in FIG. 12 and FIG. 16, when the sleeve 59 of the first mesh switching mechanism 58 is moved leftward to thus integrally join the first output shaft 13, the second output shaft 56, and the third output shaft 57 and the sleeve 66 of the second mesh switching mechanism 65 is moved leftward to thus isolate the carrier 62 of the planetary gear mechanism 60 from the casing 67, the drive range is established.

In the drive range, since the ring gear 63 and the sun gear 61 of the planetary gear mechanism 60 are joined by means of the first mesh switching mechanism 58, the planetary gear mechanism 60 attains an integrally rotatable state. As a result, the driving force outputted from the continuously variable transmission T to the first output shaft 13 is transmitted to the differential case 70 via the path: first mesh switching mechanism 58→second output shaft 56 or via the path: first mesh switching mechanism 58→third output shaft 57→sun gear 61→carrier 62→ring gear 63, thus enabling the vehicle to travel forward.

As described above, with regard to the first output shaft 13 of the continuously variable transmission T of the present embodiment, since the driving force is transmitted via the first one-way clutches 36, it can rotate only in the forward traveling direction, but it is possible by disposing the first power transmission switching mechanism S1 having the forward/reverse switching function on the downstream side of the first output shaft 13 to make the vehicle travel in reverse without carrying out hybridization by providing an electric motor for reversing.

Moreover, since the first power transmission switching mechanism S1 can establish the parking range and the neutral range in addition to the drive range and the reverse range, the vehicular power transmission device itself can be made smaller and lighter.

The operation of the second power transmission switching mechanism S2 for switching between the normal traveling/engine braking state, the idling stop state, and the fail state is now explained.

As shown in FIG. 13 to FIG. 16, in a normal state in which the first power transmission switching mechanism S1 is in any of the parking range, the reverse range, the neutral range, and the drive range, the sleeve 43 of the second power transmission switching mechanism S2 is moved leftward, thus connecting the first outer peripheral spline 55a of the transmission shaft 55 and the second outer peripheral spline 13b of the first output shaft 13. Therefore, during traveling in the drive range or the reverse range, the driving force of the engine E is not only transmitted from the input shaft 12 to the first output shaft 13 via the transmission units 14 but is also transmitted from the input shaft 12 to the transmission shaft 55 via the auxiliary driving force transmission means 54, which is formed from the first sprocket 51, the endless chain 53, and the second sprocket 52, and is transmitted from the first outer peripheral spline 55a of the transmission shaft 55 to the second outer peripheral spline 13b of the first output shaft 13.

However, since the gear ratio of the transmission units 14 is set larger than the gear ratio of the auxiliary driving force transmission means 54, the rotational speed of the transmission shaft 55 (that is, the rotational speed of the second outer peripheral spline 13b) becomes larger than the rotational speed of the first output shaft 13, the second one-way clutch 69 is disengaged, power transmission via the auxiliary driving force transmission means 54 is not carried out, and the vehicle travels forward or in reverse with power transmission via the transmission units 14.

When the vehicle, while traveling forward in the drive range, transitions to the deceleration traveling state, as shown in FIG. 17, the engine rotational speed decreases, the first one-way clutches 36 of the transmission units 14 are disengaged, and the driving force from the driven wheel is transmitted to the first output shaft 13 via the differential gear D and the first power transmission switching mechanism S1. In this process, the rotational speed of the first output shaft 13 becomes larger than the rotational speed of the transmission shaft 55 (that is, the rotational speed of the second outer peripheral spline 13b) connected to the input shaft 12 via the auxiliary driving force transmission mechanism 54, and the second one-way clutch 69 is engaged to thus transmit the driving force of the first output shaft 13 back to the engine E via the auxiliary driving force transmission means 54 and the input shaft 12, thereby enabling engine braking to be operated.

Even when the vehicle decelerates while traveling in reverse in the reverse range, since the first output shaft 13 rotates in the same direction as for forward traveling in the drive range, engine braking can be operated in the same manner.

When the vehicle further decelerates during forward traveling in the drive range, as shown in FIG. 18, the sleeve 68 of the second power transmission switching mechanism S2 is moved rightward to thus join the second outer peripheral spline 13b and the third outer peripheral spline 13c of the first output shaft 13. As a result, the first output shaft 13 rotating with the driving force transmitted back from the driven wheel is isolated from the transmission shaft 55 (that is, from the engine E), idling stop during deceleration becomes possible, and further saving of fuel consumption becomes possible.

When the transmission units 14 malfunction and the vehicle becomes unable to travel, as shown in FIG. 19, the sleeve 68 of the second power transmission switching mechanism S2 is put in the middle position to thus join the first outer peripheral spline 55a of the transmission shaft 55 and the second outer peripheral spline 13b and the third outer peripheral spline 13c of the first output shaft 13. As a result, the transmission shaft 55 and the first output shaft 13 are directly coupled without involvement of the second one-way clutch 69, and the driving force of the engine E is transmitted from the input shaft 12 to the driven wheel via the auxiliary driving force transmission means 54, the transmission shaft 55, the first output shaft 13, the first power transmission switching mechanism S1, and the differential gear D, thereby enabling the vehicle to travel forward or in reverse to a repair shop.

As described above, in accordance with the present embodiment, engine braking is enabled when traveling forward and when traveling in reverse while enabling the vehicle to travel forward and in reverse without requiring an electric motor, which would result in an increase in the axial dimension of the vehicular power transmission device and, moreover, idling stop while the vehicle is decelerating or traveling when the transmission units 14 are malfunctioning becomes possible. Furthermore, it is easy for the vehicular power transmission device to increase in the axial dimension on the input shaft 12 side to which the engine E is connected, but providing the transmission shaft 55 on the first output shaft 13 side enables any increase in the axial dimension on the input shaft 12 side to be suppressed, thus minimizing the overall axial dimension of the vehicular power transmission device.

When the vehicle transitions from the normal traveling state (acceleration traveling state or constant-speed traveling state) shown in FIG. 16 to the deceleration traveling state (engine braking state) shown in FIG. 17, the driving force from the driven wheel is transmitted back to the engine E via the second one-way clutch 69 and the auxiliary driving force transmission means 54, and engine braking operates. In this process, the second one-way clutch 69 switches from the non-engaged state to the engaged state, but the time lag required for switching varies according to the vehicle speed.

That is, since at a time of high vehicle speed the second one-way clutch 69 slips in a state in which the differential rotation is large, the time lag before the differential rotation becomes zero and the second one-way clutch 69 is engaged becomes large and, on the other hand, since at a time of low vehicle speed the second one-way clutch 69 slips in a state in which the differential rotation is small, the time lag before the differential rotation becomes zero and the second one-way clutch 69 is engaged becomes small; as a result the time before engine braking operates is nonuniform, and there is thus a possibility that the driver will experience a disagreeable sensation.

Therefore, in the present embodiment, when the vehicle transitions to the deceleration traveling state, the engine rotational speed (the rotational speed of the input shaft 12) is actively increased/decreased according to the magnitude of the differential rotation of the second one-way clutch 69, the second one-way clutch 69 can thereby be engaged regardless of the magnitude of the vehicle speed, and the time lag before engine braking operates is made uniform, thus eliminating any disagreeable sensation for the driver. The increase/decrease of the engine rotational speed employs the driving force of the electric motor 24 of the shift actuator 23, the load when the generator G generates power, and the driving force when the generator G is driven as a motor.

The method for actively increasing and decreasing the engine rotational speed by means of the shift actuator 23 is first explained.

When the gear ratio is UD, the first engagement portion 43a of the first connecting member 43, which is integrated with the input shaft 12, and the second engagement portion 44a of the second connecting member 44, which is integrated with the gear shaft 15, abut against each other (see FIG. 9 (A)). The first connecting member 43 integrated with the input shaft 12 stops when the engine E stops, and when in this state the electric motor 24 is driven in one direction, the first ring gear 30 and the second ring gear 31 are rotated relative to each other by means of the planetary gear mechanism 25 of the shift actuator 23. Since the first connecting member 43, which is integral with the first ring gear 30, is connected to the input shaft 12 and stopped, the second connecting member 44 integrated with the second ring gear 31 rotates in the clockwise direction in the figure relative to the first connecting member 43, and the gear ratio changes toward OD (see FIG. 9 (B)). That is, when the gear ratio changes between UD and OD, the second engagement portion 44a of the second connecting member 44 does not press the first engagement portion 43a of the first connecting member 43.

When the engine E is stopped, if in a state in which the gear ratio is UD the electric motor 24 is driven in the other direction, the second connecting member 44 rotates in the counterclockwise direction in the figure with respect to the first connecting member 43, which is stopped, the second engagement portion 44a of the second connecting member 44 presses the first engagement portion 43a of the first connecting member 43, and the first connecting member 43 and the second connecting member 44 thereby rotate in the counterclockwise direction in the figure (see FIG. 9 (C)). As a result, the input shaft 12 connected to the first connecting member 43 rotates, and the engine E connected to the input shaft 12 can be driven in the forward rotation direction.

When the engine E is stopped, if in a state in which the gear ratio is OD the electric motor 24 is driven in said one direction, the second connecting member 44 rotates in the counterclockwise direction in the figure with respect to the first connecting member 43, which is stopped, the second engagement portion 44a of the second connecting member 44 presses the first engagement portion 43a of the first connecting member 43, and the first connecting member 43 and the second connecting member 44 thereby rotate in the counterclockwise direction in the figure (see FIG. 9 (D)). As a result, the input shaft 12 connected to the first connecting member 43 rotates, and the engine E can be driven in the reverse rotation direction.

A case where the engine E is stopped (when the input shaft 12 is stopped) is explained above, but in a case where the engine E is running, increasing or decreasing the rotational speed of the electric motor 24 with reference to the engine rotational speed also enables the first connecting member 43 and the second connecting member 44 to be rotated relative to each other in any direction, thereby enabling the rotation of the engine E to be assisted or braked.

Engine braking control when the vehicle transitions to the deceleration traveling state is now explained by reference to the flowchart of FIG. 20.

First, when in step S1 the vehicle transitions to the deceleration traveling state and the engine E decelerates with fuel cut-off, if in step S2 the differential rotation of the second one-way clutch 69 is at least the preset first rotational speed due to the vehicle speed being high, then in step S3 the electric motor 24 of the shift actuator 23 is driven so as to apply a braking force to the rotation of the input shaft 12 (rotation of the engine E) and the generator G is operated so as to generate power for driving the electric motor 24; by applying the braking force to the rotation of the engine E with the load of the generator G the differential rotation of the second one-way clutch 69 is quickly decreased, thereby decreasing the time lag before the second one-way clutch 69 is engaged and engine braking operates.

In this process, the magnitude of a target load torque to be generated by the shift actuator 23 and the generator G is determined by multiplying the differential rotation of the second one-way clutch 69 by a predetermined coefficient K1. The (−1) symbol in the equation denotes the direction in which the load torque decreases the rotation of the engine E.

On the other hand, if in step S4 the differential rotation is less than the second rotational speed, which is smaller than the first rotational speed, due to the vehicle speed being low, then in step S5 the electric motor 24 of the shift actuator 23 is driven to thus apply an assisting force to the rotation of the input shaft 12 (rotation of the engine E) and the generator G is made to function as a motor by means of battery power to thus apply the assisting force to rotation of the engine E, the differential rotation of the second one-way clutch 69 is thereby slowly decreased, thus increasing the time lag before the second one-way clutch 69 is engaged and engine braking operates.

In this process, the magnitude of a target assist torque to be generated by the shift actuator 23 and the generator G is determined by multiplying the differential rotation of the second one-way clutch 69 by a predetermined coefficient K2.

As described above, when the vehicle transitions to the deceleration traveling state, the engine rotational speed is actively increased/decreased in response to the magnitude of the differential rotation of the second one-way clutch 69, the time taken for the differential rotation to become zero and for the second one-way clutch 69 to be engaged is made to converge to the target time, and the time lag before engine braking operates (vehicle free traveling distance) is made uniform, thus enabling any disagreeable sensation for the driver to be eliminated.

In the embodiment above, the differential rotation of the second one-way clutch 69 is controlled by use of both the electric motor 24 of the shift actuator 23 and the generator G, but use of the generator G is not essential, and the generator G may be used only when a required load torque or assist torque is large.

The operation is now further explained using the time charts in FIG. 21 and FIG. 22.

The time chart of FIG. 21 corresponds to a case in which the differential rotation of the second one-way clutch 69 is large; when at time t1 the vehicle transitions to the deceleration traveling state, since the differential rotation is at least the first rotational speed, in order to quickly decrease the differential rotation, a braking force is applied to the rotation of the engine E by means of the shift actuator 23 and the generator G. As a result, the differential rotation quickly decreases and becomes zero at time t2, engine braking operates, and the vehicle speed therefore rapidly decreases.

The time chart of FIG. 22 corresponds to a case in which the differential rotation of the second one-way clutch 69 is small; when at time t1 the vehicle transitions to the deceleration traveling state, since the differential rotation is less than the second rotational speed, in order to slowly decrease the differential rotation, an assisting force is applied to rotation of the engine E by means of the shift actuator 23 and the generator G. As a result, the differential rotation slowly decreases and becomes zero at time t2, engine braking operates, and the vehicle speed rapidly decreases.

When the differential rotation of the second one-way clutch 69 is large as shown in FIG. 21, in a conventional example engine braking operates at time t3, whereas in the present embodiment engine braking can be operated at time t2, which is earlier than time t3, and when the differential rotation of the second one-way clutch 69 is small as shown in FIG. 22, in the conventional example engine braking operates at time t3′, whereas in the present embodiment engine braking can be operated at time t2, which is later than time t3′. This enables engine braking to be operated at time t2, which is the same timing for both cases, thus eliminating any disagreeable sensation for the driver.

An embodiment of the present invention is explained above, but the present invention may be modified in a variety of ways as long as the modifications do not depart from the spirit and scope thereof.

For example, since the shift actuator of the present invention may be formed using any type of reduction mechanism, it is not limited to one in which the planetary gear mechanism 25 of the embodiment is used, and it may be one in which a hypocycloid mechanism is used or one in which a wave gear mechanism such as a Harmonic Drive (registered trademark) is used.

Furthermore, in the embodiment the outer peripheral part of the first connecting member 43 and the outer peripheral part of the second connecting member 44 are provided with the first engagement portion 43a and the second engagement portion 44a respectively, but a first engagement portion 43a and a second engagement portion 44a may be provided at any position of a first connecting member 43 and a second connecting member 44.

Moreover, the members on which the first engagement portion and the second engagement portion are provided are not limited to the first connecting member 43 and the second connecting member 44; they may be two members that undergo relative movement according to a change in the gear ratio and, for example, a first engagement portion and a second engagement portion may be provided on two eccentric disks 19 and 19 that are adjacent in the axial direction.

1. A vehicular power transmission device comprising:
an input shaft that is connected to an engine,
an output shaft that is disposed in parallel to the input shaft,
a swinging link that is swingably supported on the output shaft,
a first one-way clutch that is disposed between the output shaft and the swinging link, and that is engaged when the swinging link swings in one direction, and that releases engagement when the swinging link swings in the other direction,
an eccentric member that rotates eccentrically integrally with the input shaft,
a gear shaft that is disposed coaxially with the input shaft and changes an amount of eccentricity of the eccentric member,
a shift actuator that makes the gear shaft rotate relative to the input shaft,
an electric motor that drives the shift actuator,
a connecting rod that connects the eccentric member and the swinging link,
auxiliary driving force transmission means that can transmit a driving force from the output shaft to the input shaft, and
a second one-way clutch that is disposed in the auxiliary driving force transmission means and that is engaged when the rotational speed of the output shaft is at least the rotational speed of the input shaft, wherein
the shift actuator comprises a first member that is connected to the input shaft, a second member that is connected to the gear shaft, a third member that is connected to the electric motor and that drives the first and second members at different rotational speeds, and engagement portions that engage with each other when the first and second members are in a predetermined phase and that are capable of transmitting rotation of the second member directly to the first member, and
when the vehicle transitions from an acceleration traveling state or a constant-speed traveling state to a deceleration traveling state, the driving force of the electric motor is transmitted to the input shaft via the engagement portion so that the time taken for the second one-way clutch to switch from a non-engaged state to an engaged state coincides with a preset predetermined time.

2. The vehicular power transmission device according to claim 1, wherein when the differential rotation of the second one-way clutch is a predetermined value or greater, rotation of the input shaft is braked by the driving force of the electric motor.

3. The vehicular power transmission device according to claim 2, further comprising:
a generator connected to the engine, the electric motor being driven with power generated by the generator.

4. The vehicular power transmission device according to claim 2, wherein the larger the differential rotation of the second one-way clutch, the further the driving force of the electric motor is increased.

5. The vehicular power transmission device according to claim 3, wherein when the differential rotation of the second one-way clutch is less than a predetermined value, rotation of the input shaft is assisted by the driving force of the electric motor or the driving force of the generator operating as a motor.

6. The vehicular power transmission device according to claim 3, wherein the larger the differential rotation of the second one-way clutch, the further the driving force of the electric motor is increased.
